(19) United States
(12) Patent Application Publication
(10) Pub. No.: US 2011/0096468 A1
(43) Pub. Date: Apr. 28, 2011

(54) Medium-voltage switchgear

(76) Inventor: Harald Fink, Ratingen (DE)

(21) Appl. No.: 10/578,277

(22) PCT Filed: Nov. 5, 2004
(86) PCT No.: PCT/EP04/12508

§ 371 Date: May 5, 2006

(30) Foreign Application Priority Data
Nov. 7, 2003 (DE) 103 51 948.3

(51) Int. Cl. H02B 7/01; H02B 7/00

(52) U.S. Cl. 361/618; 361/605

(57) ABSTRACT

The invention relates to a medium voltage switchgear, comprising at least two switchboard sections, as according to the generic part of patent claim 1. According to the invention, a compact construction of a medium voltage switchgear with guaranteed secure insulation within the switchgear housing may be achieved, whereby, within a switchgear housing, at least one load switching field and at least one power switching field are arranged in common, or with a common opposing face and both the load switching field and the power switching field are embodied as vacuum switches.

The invention relates to a medium-voltage switchgear assembly having at least 2 switch panels, as claimed in the precharacterizing clause of patent claim 1.

Medium-voltage switchgear assemblies are known per se and are provided with so-called load switches and/or power switches or circuit breakers.

In one known embodiment, circuit breakers are known as vacuum switches within a switchgear assembly enclosure. If load switches are also present, then these are in general not in the form of vacuum switches. In order to ensure appropriate isolation as well as quenching when load switches are open, switchgear assembly enclosures are filled with insulating gas. SF₆ is often used as the insulating gas in this case.

In the case of switchgear assemblies of this type, the switches are each provided for all three phases of a three-phase system, so that each switch is in the form of a three-phase switching element.

When switching processes occur, marks occur to a greater or lesser extent depending on whether switching takes place on no-load or possibly even with short-circuit currents. In all cases, that is to say in cases of no-load switching processes, the switchgear assembly must be just as safe and must switch, as in fault situations, that is to say in the event of short-circuit currents.

One important criterion is thus the stated isolation. Since switchgear assemblies of this type are operated with a root mean square phase voltage of up to about 50 kV, this results in minimum physical separations.

The invention is thus based on the object of further developing a medium-voltage switchgear assembly of this generic type so as to provide a more compact form while at the same time ensuring reliable isolation within the switchgear assembly enclosure.

In the case of a medium-voltage switchgear assembly of this generic type, the stated object is achieved, according to the invention, by the characterizing features of patent claim 1.

Further advantageous refinements are specified in the dependent claims.

The essence of the invention is that at least 1 load switch panel and 1 power switch panel are arranged jointly or compartmentalized from one another within a switchgear assembly enclosure, and in that both the load switch panel and the power switch panel are designed with a vacuum switch.

This ensures a high degree of compactness while at the same time satisfying the isolation requirements within the switchgear assembly. In contrast to this, so-called gas-insulated switchgear assemblies are provided with vacuum switching chambers only in the area of the circuit breakers. Load switches in gas-insulated switchgear assemblies are normally built with open contacts, with insulating gas, for example SF₆, being provided in the interior of the switchgear assembly. However, in the present case, both load switches and circuit breakers are designed with vacuum switching chambers, thus allowing them to be made considerably more physically compact in this way than in the case of switchgear assemblies of the described known type.

A further advantageous refinement provides for 2 load switch panels and 1 power switch panel to be arranged in the switchgear assembly. The type according to the invention and as claimed in claim 1 leads in conjunction with this refinement to a high degree of compactness and functionality.

Furthermore, the interior of the switchgear assembly enclosure can be filled with insulating gas. This is optional in order to ensure good isolation between live parts outside the actual switching chambers.

Thus, in a further refinement, isolators can be arranged within the switchgear assembly enclosure, and can be isolated either by the insulation gas within the switchgear assembly enclosure, or in some other way.

It is possible to entirely dispense with insulating gas if it has a quenching function at the same time, when the isolator or isolators is or are in the form of a switch or switches with a vacuum chamber.

A further advantageous refinement provides for the isolator or isolators to be in the form of a three-position vacuum switch or switches. This allows the three switch positions “closed”, “open” and “grounded” to be used in one isolator, and in particular independently of any insulating gas within the switchgear assembly.

A further advantageous refinement provides for the switches and/or the vacuum chambers to be surrounded by solid insulation. This allows the vacuum switching chambers to be arranged very compactly.

One exemplary embodiment of the invention will be described in more detail in the following text and is illustrated in the drawing, in which:

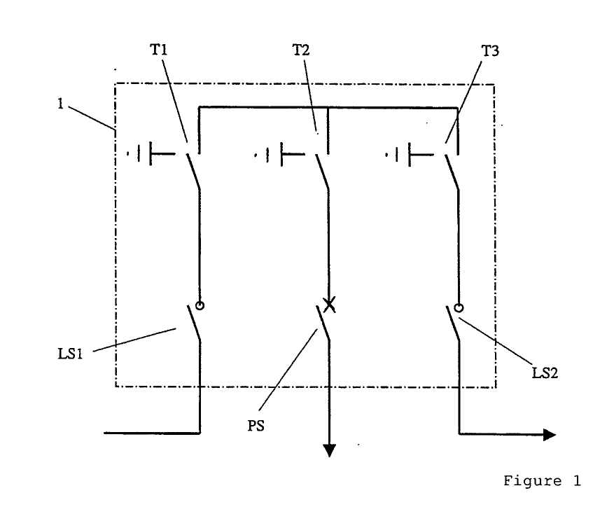

FIG. 1 shows a switching function illustration and

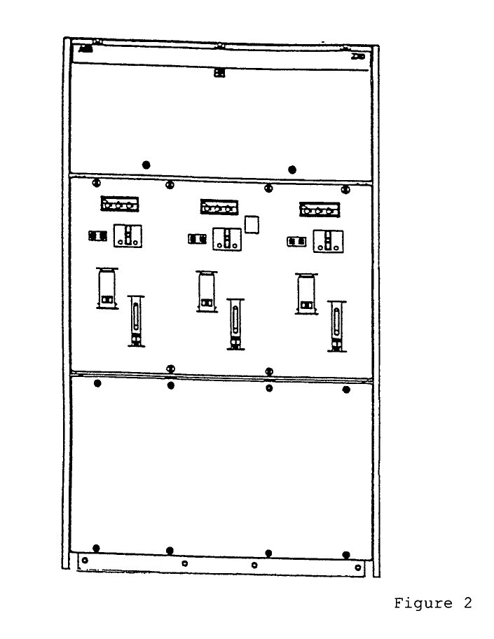

FIG. 2 shows a switchgear assembly enclosure.

FIG. 1 shows the switching sketch for a switching block comprising three switch panels. The illustrated path is shown here for only one phase. In fact, this path exists for the three phases L1, L2 and L3, that is to say three times in one switchgear assembly. This means that each illustrated switch in each case represents the switches for all three phases, of which only one is illustrated here. A switch which is in each case not illustrated is then part of a so-called switch panel. The two outer switch panels contain load switches LS1 and LS2, and the central switch panel contains a power switch PS.

The power switch PS is in this case used as an outgoer to the transformer or motor, or other mode, and/or as an outgoer for a further load switch panel in order to continue the ring. The load switches LS1, LS2 are once again connected to other switchgear assemblies, or to the ring cable panel, which is not illustrated in any more detail here.

The load switches LS1 and LS2 are in this case connected together in series phase-by-phase, and are also connected in parallel with the power switch PS. So-called isolators T1, T2 and T3 are arranged above the switches or switch panels. These isolators are in the form of three-position switches, and have the switch positions “closed”, “open” and “grounded”.

According to the invention, the load and power switches LS1, LS2, . . . as well as PS are now in the form of switches with vacuum chambers, thus resulting in a very compact form since this makes it possible to achieve considerably shorter isolating separations.

Furthermore, the isolators T1, T2, T3 may also be in the form of switches with vacuum chambers.

FIG. 2 shows a so-called ring cable panel (RKF) which comprises three switch panels.

In the case of a ring cable panel, 3 switch panels generally form a switching block. The switching block is in the form of encapsulation, that is to say the individual panels are not compartmentalized from one another in this case.

The switching block includes a load switch panel for the introduction of the ring, a load switch panel as an outgoer to the transformer or motor and/or a further load switch panel in order to continue the ring. Load switches and circuit breakers are in this case both in the form of vacuum switching devices, in the manner according to the invention. Each of the 3 switching devices has, in conjunction with the busbar, a conventional three-position switch as an isolator, which in this case may be in the form of a so-called linear-travel switch.

The compactness of this encapsulation, which may possibly not be filled with SF₆, that is to say the enclosure of the switchgear assembly, is achieved by using vacuum chambers instead of the conventional, for example air-quenching, load switches which have correspondingly large dimensions, and these are also encapsulated in casting resin, for dielectric reasons. In consequence, locations of increased field strength are at the same time dielectrically shielded. The vacuum chambers carry out all of the switching tasks.

The three-position switch is likewise of a compact design since, although it has to provide isolation, it does not have to switch any currents, and switches on no-load. This requires specific interlocks with the actual switching device. Rounded electrodes and components lead to the electrical field strengths being smoothed out.

It should expressly be noted that—as already known—the compactness is not based on the use of SF₆, which has a high dielectric strength. In our case, the ring cable panel is filled with N₂, whose dielectric strength is three-times poorer.

A ring cable panel may also comprise more than 3 panels.

A switching block in each case has a common gas area and forms a transport unit. The switching blocks are removed completely on a factory-complete basis and are delivered as a closed system on a primary and secondary-tested basis.

The panels of a switching block can also be compartmentalized from one another to be gas-tight. The switching blocks can in turn be connected to one another on the busbar side using known plug-in technology.

The cable plug systems may be designed with an inner or outer cone. In the present example here, an inner cone system is used.

The various switch panel variants with circuit breakers or load switches as well as busbar longitudinal coupling with risers or busbar grounding may be joined together in any desired sequence to form switching blocks.

In general, standard components are used so that it is also possible to replace or upgrade switchgear assemblies or panels which are already in use.

1. A medium-voltage switchgear assembly having at least two switch panels,
characterized in that
at least 1 load switch panel (LS1, . . . ) and 1 power switch panel (PS) are arranged jointly or compartmentalized from one another within a switchgear assembly enclosure (1), and in that both the load switch panel and the power switch panel are designed with a vacuum switch.

2. The medium-voltage switchgear assembly as claimed in claim 1,
characterized in that
2 load switch panels (LS1, LS2) and 1 power switch panel (PS) are arranged in the switchgear assembly.

3. The medium-voltage switchgear assembly as claimed in claim 1 or 2,
characterized in that
the interior of the switchgear assembly enclosure (1) is filled with insulating gas.

4. The medium-voltage switchgear assembly as claimed in one of the preceding claims,
characterized in that
isolators (T1, T2, T3) are arranged within the switchgear assembly enclosure (1).

5. The medium-voltage switchgear assembly as claimed in claim 4,
characterized in that
the isolator or isolators is or are in the form of a switch or switches with a vacuum chamber.

6. The medium-voltage switchgear assembly as claimed in claim 5,
characterized in that
the isolator or isolators (T1, T2, T3) is or are in the form of a three-position vacuum switch or switches.

7. The medium-voltage switchgear assembly as claimed in one of the preceding claims,
characterized in that
the switches and/or the vacuum chambers are surrounded by solid insulation.
